(19) United States
(12) Patent Application Publication
(10) Pub. No.: US 2024/0102605 A1
(43) Pub. Date: Mar. 28, 2024

(54) MULTI-LEGGED EQUIPMENT SUPPORT HAVING LEG ANGLE ADJUSTMENT

(71) Applicant: AOB Products Company, Columbia, MO (US)

(72) Inventors: Brian Steere, Columbia, MO (US); Michael Cottrell, Ashland, MO (US); Timothy S. Kinney, Warrenton, MO (US); James Tayon, Moberly, MO (US); Jason Nickerson, Columbia, MO (US); Justin Burke, Columbia, MO (US); Anthony Vesich, Columbia, MO (US); Dennis W. Cauley, JR., Fayette, MO (US); Mark Dalton, Columbia, MO (US); Kyle Smith, Columbia, MO (US)

(73) Assignee: AOB Products Company, Columbia, MO (US)

(21) Appl. No.: 18/535,130

(22) Filed: Dec. 11, 2023

Related U.S. Application Data
(63) Continuation of application No. 17/124,560, filed on Dec. 17, 2020, now Pat. No. 11,841,108.
(60) Provisional application No. 62/948,946, filed on Dec. 17, 2019.

(51) Int. Cl. F16M 11/16; F16M 11/34

(52) U.S. Cl. CPC F16M 11/16; F16M 11/34

(57) ABSTRACT

A multi-legged equipment support, components thereof, and associated methods. The equipment support comprises a stand and an equipment holder. The stand includes a hub and multiple legs pivotable with respect to the hub. The legs are pivotable outward from stowed positions to preset operational pivoted positions. The user can select a preset operational pivoted position in which outward pivoting of a leg will stop based on moving an actuator between preset locations.

### CROSS-REFERENCE TO RELATED APPLICATION

The present application is a continuation of U.S. Nonprovisional patent application Ser. No. 17/124,560, filed Dec. 17, 2020, and claims priority to U.S. Provisional Patent Application No. 62/948,946, filed Dec. 17, 2019, each of which are hereby incorporated by reference in their entirety.

### FIELD

The present disclosure generally relates to equipment supports, and more particularly to stands such as bipods, tripods, etc., for supporting equipment such as weapons, optics, cameras, or other equipment.

### BACKGROUND

Bipods, tripods, and other types of equipment stands are used to support various types of equipment. For example, hunters may use such stands to support an optic (e.g., spotting scope), a weapon (e.g., rifle), or a camera. Such equipment supports are also used in other areas.

### SUMMARY

In one aspect, a multi-legged equipment support comprises a hub and a set of legs. The set of legs includes at least first and second legs. Each leg of the set of legs includes a head. Each head is pivotably connected to the hub for pivoting about a respective pivot axis. Each leg is pivotable with respect to the hub about the respective pivot axis outward from a stowed position to at least one operational pivoted position. The equipment support includes leg angle stop structure including a first stop and a corresponding first set of blockers. At least one of the first leg or the hub includes the first stop. The other of the at least one of the first leg or the hub includes the first set of blockers. The first set of blockers comprises a first first leg blocker and a second first leg blocker. At least one of the first stop or the first set of blockers is movable with respect to the hub to selectively arrange the first stop in registration with at least one of the first first leg blocker or second first leg blocker. The first first leg blocker is arranged to engage the first stop when the first stop is in registration with the first first leg blocker to stop outward pivoting of the first leg at a first preset operational pivoted positon of the first leg. The second first leg blocker is arranged to engage the first stop when the first stop is in registration with the second first leg blocker to stop outward pivoting of the first leg at a second preset operational pivoted position of the first leg. The first leg is pivotable outward a greater degree from the stowed position to the second preset operational pivoted position than from the stowed position to the to the first preset operational pivoted position.

In another aspect, a multi-legged equipment support comprises a hub and a set of legs. The set of legs includes at least first and second legs. Each leg of the set of legs includes a head. Each head is pivotably connected to the hub for pivoting about a respective pivot axis. At least the first leg is pivotable with respect to the hub about the respective pivot axis outward from a stowed position to at least first and second preset operational pivoted positions. A first actuator is associated with the first leg. The first actuator is movable with respect to the head of the first leg between first and second preset locations. The first leg is pivotable outward from the stowed position to the first preset operational pivoted position when the first actuator is in the first preset location. The first leg is pivotable outward from the stowed position to a second preset operational pivoted position different from the first preset operational pivoted position when the first actuator is in the second preset location. A first retainer is arranged to maintain the first actuator in at least one of the first preset location or the second preset location irrespective of the first leg being in the first or second operational pivoted positions.

Other objects and features of the present disclosure will be in part apparent and in part pointed out herein.

### BRIEF DESCRIPTION OF THE DRAWINGS

FIG. 1 is a perspective of a multi-legged support of the present disclosure;

FIG. 2 is a fragmentary perspective of the multi-legged support;

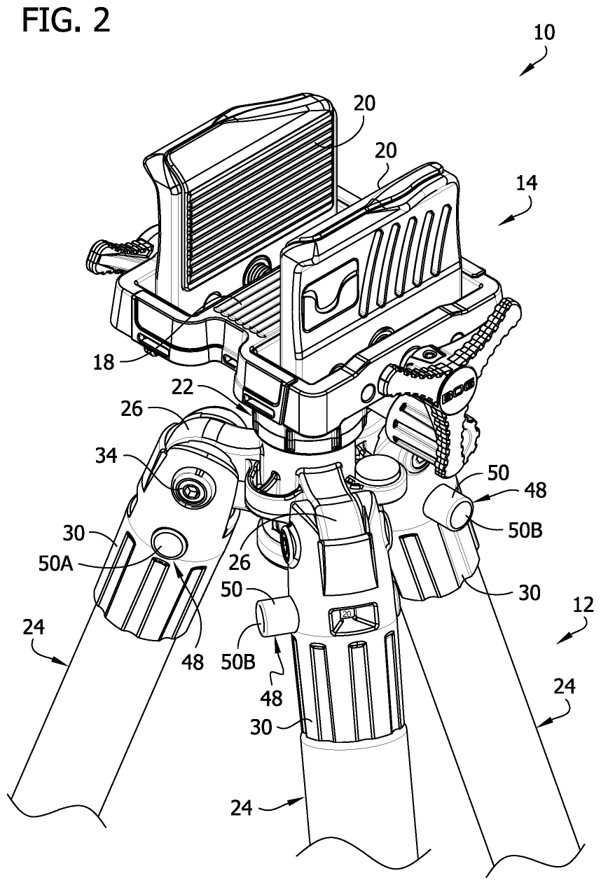

FIG. 3 is a fragmentary front elevation of the multi-legged support;

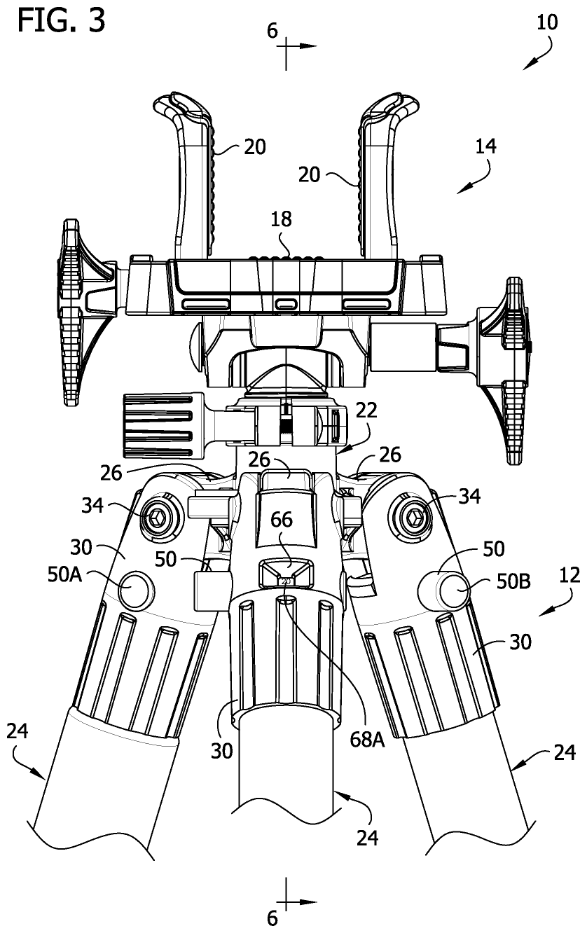

FIG. 4 is a fragmentary front elevation of the multi-legged support, a head of a leg of the multi-legged support removed;

FIG. 5 is a fragmentary bottom perspective of the multi-legged support having legs and two of three leg angle adjusters removed;

FIG. 6 is a fragmentary section of the multi-legged support taken in a plane including line 6-6 of FIG. 3; and

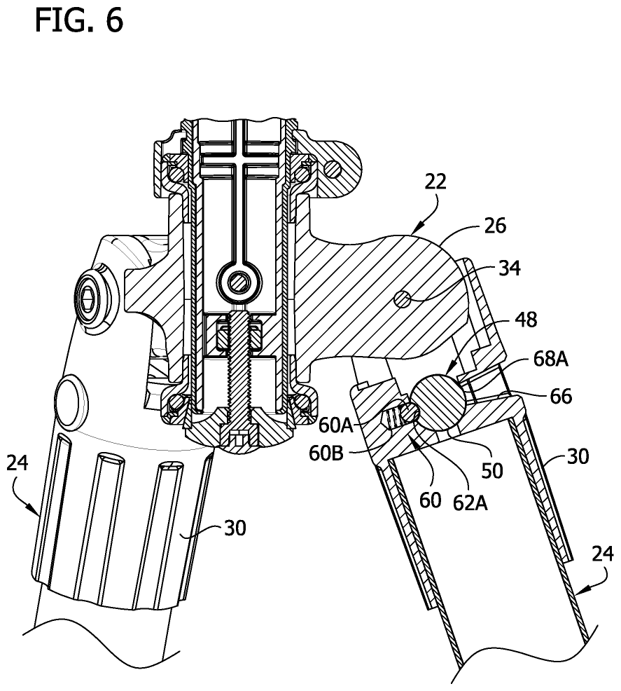

FIG. 7 is a perspective of a leg angle adjuster of the multi-legged support.

Corresponding reference numbers indicate corresponding parts throughout the drawings.

### DETAILED DESCRIPTION

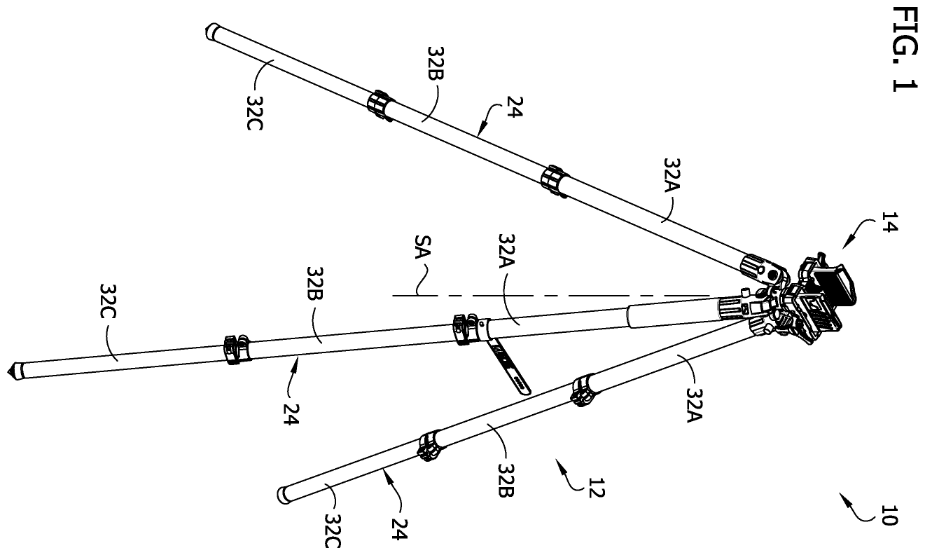

Referring to FIG. 1, a multi-legged support of the present disclosure is indicated by 10. The multi-legged support can be used to support a variety of objects, such as cameras, optics, and/or weapons (e.g., firearm), collectively referred to hereafter as equipment. In the illustrated embodiment, the multi-legged support 10 comprises a tripod having three legs, but it will be understood that multi-legged supports having other numbers of legs (e.g., two, four, etc.) can be used without departing from the scope of the present disclosure.

The multi-legged support 10 includes a frame 12 and an equipment holder 14 (broadly, “equipment support”) supported by the frame. The equipment holder 14 includes a cradle comprising a bed 18 and opposing jaws 20 for clamping equipment to be supported by the multi-legged support 10. The equipment holder 14 is adjustable (e.g., pivotable about multiple axes) to change an orientation of the supported equipment with respect to the frame 12. It will be appreciated that other types of equipment holders can be used without departing from the scope of the present disclosure. For example, the equipment holder may be configured to support the equipment in other ways (e.g., without clamping). The equipment holder 14 may have a construction and connection to a hub 22 such as disclosed in co-assigned U.S. Pat. No. 10,514,225, which is hereby incorporated by reference in its entirety.

The frame 12 includes a stand comprising the hub 22 and a plurality of legs 24. The hub 22 includes three arms 26 protruding radially from a main body of the hub. The legs 24 each comprise a head 30 and a plurality of telescopically connected leg sections 32A-32C extending downward from the head. The legs 24 can be extended and retracted by telescoping the leg sections 32A-32C out of and into each other. The heads 30 are pivotably connected to the arms 26 of the hub by fasteners 34 defining pivot connections.

The legs 24 are pivotable about the pivot connections between stowed positions and operational (deployed) positions. In a stowed configuration (not shown) of the multi-legged support 10, the legs 24 are pivoted toward each other to extend generally alongside each other and alongside and/or generally parallel to a stowed axis SA extending downward from the equipment holder 14. In such a configuration, the legs 24 could be retracted to provide a compact stowed arrangement. In an operational configuration (e.g., FIG. 1) of the multi-legged support 10, the legs 24 (retracted, or partially or fully extended) are pivoted away from each other (and away from the stowed axis SA). Each leg 24 is pivotable to a plurality of preset operational pivoted positions in which the legs extend at predetermined angles with respect to the stowed axis SA. In the illustrated embodiment, the legs 24 can be pivoted to three different preset operational pivoted positions. It will be appreciated that, if desired, the legs 24 can be pivoted to non-preset positions in the range of movement between the stowed and preset positions. Moreover, other numbers of preset positions could be provided without departing from the scope of the present disclosure.

The hub 22 and legs 24 include corresponding leg angle stop structure configured to stop pivoting of the legs and define the preset operational pivoted positions of the legs. In the illustrated embodiment, the leg angle stop structure includes a plurality of blockers 40, 42, 44 (each having a respective blocking surface) on each arm 26, and stops 46 defined by adjusters 48 carried by the heads 30 of the legs 24. In a preset operational pivoted position of a leg 24, the stop 46 abuts a selected one of the blockers 40, 42, 44 (whichever blocker the stop is in registration with) to stop and/or prevent further outward pivoting movement of the leg.

In the illustrated embodiment, each leg 24 has three preset operational pivoted positions defined by the blockers 40, 42, 44. A first preset operational pivoted position is defined by a first blocker 40. A second preset operational pivoted position is defined by a second blocker 42. A third preset operational pivoted position is defined by a third blocker 44. The three blockers 40, 42, 44 are angularly offset with respect to the pivot axis of the leg 24. In the second preset operational pivoted position (not shown), the leg 24 is pivoted outwardly more (a greater degree with respect to the stowed axis SA) than in the first operational position (e.g., FIG. 1), and in the third operational position (not shown) the leg is pivoted outwardly more than in the second operational position. For example without limitation, the first blocker 40 may permit pivoting of the leg to a 20 degree angle (broadly, in an inclusive range of between 10 and 45 degrees) with respect to the stowed axis SA (e.g., for use in a standing position), the second blocker 42 may permit pivoting of the leg to a 45 degree angle (broadly, in an inclusive range of between 25 and 70 degrees) with respect to the stowed axis (e.g., for use in a sitting position), and the third blocker 44 may permit pivoting of the leg to an 85 degree angle (broadly, in an inclusive range of between 70 and 90 degrees) with respect to the stowed axis (e.g., for use in a prone position). Other angles can be used without departing from the scope of the present disclosure.

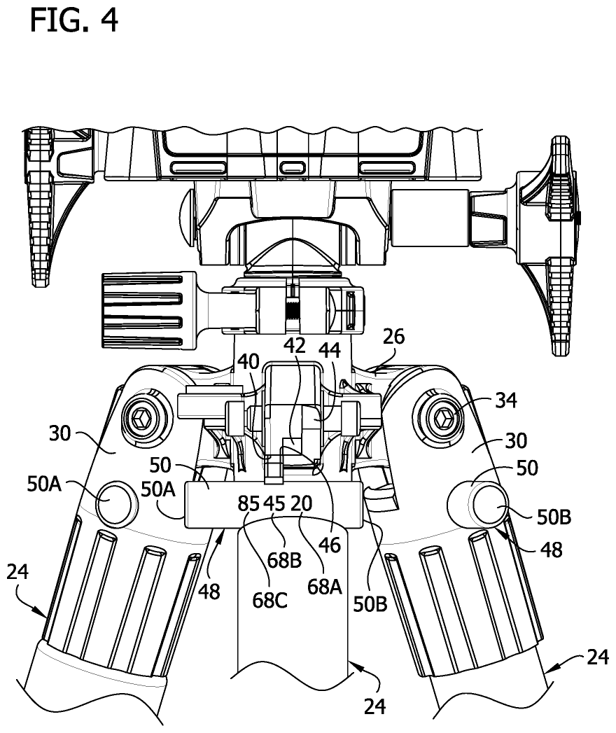

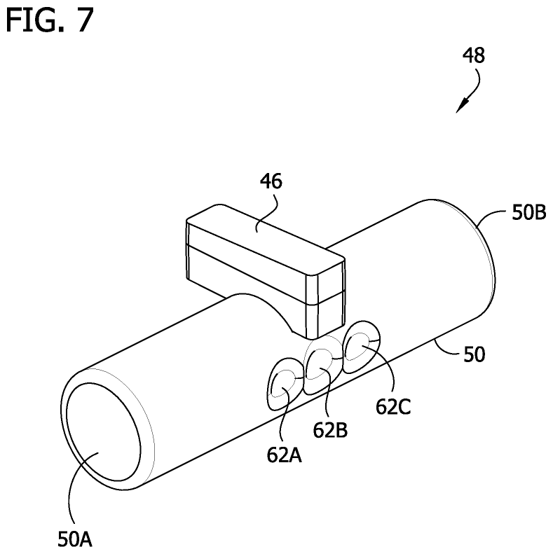

Referring to FIGS. 4, 5, and 7, the adjusters 48 comprise slides 50 (broadly, “actuators”) slidably received in tracks in the leg heads 30. Each slide 50 has opposing press surfaces 50A, 50B on opposite ends of the slide that are exposed outside the leg head 30 for being pressed by a finger of a user for moving the slide in opposite first and second directions transverse to a longitudinal axis of the leg. The stop 46 is connected to an upper side of the slide 50 and moves conjointly with the slide. The stop 46 is carried by an intermediate portion of the slide 50 housed in the head 30. The stop 46 has an upper stop surface arranged to engage a selected one of the blockers 40, 42, 44 (whichever blocker is in registration with the stop) to stop pivoting of the leg. The arrangement is such that a user can press on one of the opposing press surfaces 50A, 50B to slide the slide in one of the opposite first or second directions (e.g., left or right) to arrange the stop 46 in registration with a selected one of the blockers 40, 42, 44 to select a desired preset operational position of the leg. When the slide is in the desired preset location, the leg is pivoted outward, and pivoting of the leg is stopped by engagement of the stop 46 with the blocker in registration with the stop.

The frame 12 includes retaining structure configured to retain the adjusters 48 in position. In the illustrated embodiment, the retaining structure comprises detents 60 for each of the legs 24. Each detent comprises a ball 60A biased by a spring 60B in an opening in the leg head 30. The retaining structure further comprises recesses 62A-62C in the slide 50 configured to receive the ball 60A. Each recess 62A-62C corresponds to a position of the slide 50 corresponding to a different preset operational pivoted position of the leg 24. A first recess 62A corresponds to the first preset operational pivoted position such that when the ball 60A is received in the first recess the stop 46 is in registration with the first blocker 40 for engaging the first blocker. A second recess 62B corresponds to the second preset operational pivoted position such that when the ball 60A is received in the second recess the stop 46 is in registration with the second blocker 42 for engaging the second blocker. A third recess 62C corresponds to the third preset operational pivoted position such that when the ball 60A is received in the third recess the stop 46 is in registration with the third blocker 44 for engaging the third blocker. The arrangement is such that the ball 60A is displaced from the retaining position (out of any one of the recesses 62A-62C) to permit movement of the actuator 50 in the first or second direction responsive to force on the actuator tending to move the actuator in the respective first or second direction. When the ball 60A moves into registration with the next recess 62A-62C, the ball is resiliently pushed into the recess by the spring 60B. The detent 60 and/or associated recesses 62A-62C can collectively be referred to as a retainer for maintaining an actuator in one or more of the preset locations.

It will be appreciated that when the adjusters 48 are in the preset locations for selecting a preset operational pivoted leg position, the adjusters are free of spring bias tending to bias the adjusters in either the first direction or the second direction. Desirably, when the adjusters 48 are in the preset locations, the adjusters are maintained in such locations notwithstanding whether the stops 46 are in engagement with one of the blockers 40, 42, 44. However, other arrangements can be used without departing form the scope of the present disclosure.

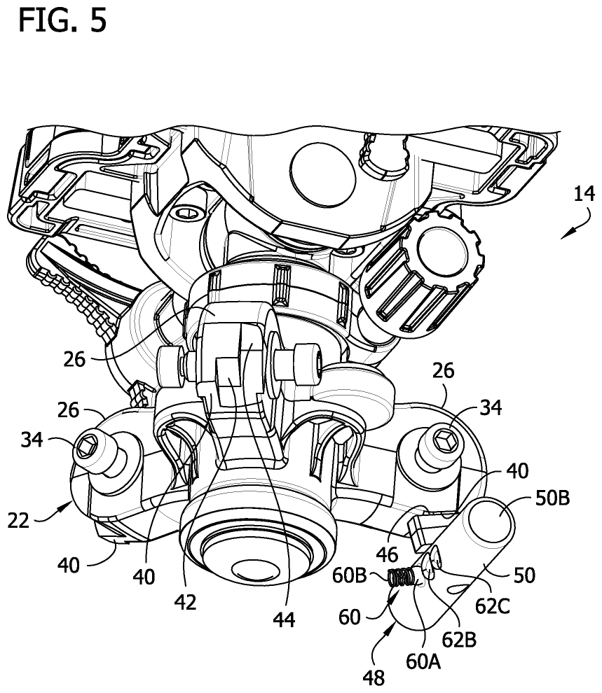

The head 30 of each leg 24 defines a window 66 (broadly, “opening”) through which the adjuster 48 and in particular indicators 68A-68C on the slide 50 are visible for showing the user what preset operational pivoted position of the leg has been selected based on the current position of the slide. The window 66 can also be broadly referred to as a reference with respect to which a user references a position of the indicator 68A-68C corresponding to the preset operational position in the particular position of the slide 50. Referring to FIGS. 4 and 5, the indicators 68A-68C are provided on the slide 50 to indicate to the user the preset operational pivoted position of the leg 24 based on which indicator is exposed or viewable through the window 66. In the illustrated embodiment, the indicators 68A-68C comprise numbers (20, 45, 85) corresponding to the degrees the leg 24 is pivotable away from the storage axis SA when the leg is pivoted to the preset operational position. When the slide 50 is in a preset location, the corresponding indicator 68A-68C is visible in the window 66, and the other indicators are hidden from view (inside the head 30). Other types of indicators (e.g., icons, labels, colors, etc.) can be used without departing from the scope of the present disclosure.

In use, by reference to the indicators 68A-68C on the adjusters 48, the user can slide the adjusters of the three legs 24 to select a desired preset operational pivoted position of each leg (which can be the same or different among the legs) and then pivot the legs outwardly until further pivoting movement is prevented by engagement of the stops 46 with the blockers 40, 42, 44 in registration with the stops defining the selected operational positions for each leg.

It will be apparent that modifications and variations are possible without departing from the scope of the invention defined in the appended claims. For example, the locations of the stops 46 and the blockers 40, 42, 44 on the legs and hub can be swapped, such that the stops are provided on the hub and the blockers on the legs. Moreover, the blockers may be movable with respect to a fixed stop, rather than the stop being movable with respect to the blockers. Moreover, the locations of the detents 60 and the recesses 62A-62C on the leg heads 30 and actuators 50 can be swapped, such that the detents are provided on the leg heads and the recesses on the actuators. Other types, arrangements, numbers, and/or configurations of legs, hubs, actuators, retaining structure, and leg angle stop structure can be used without departing from the scope of the present disclosure.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A multi-legged equipment support comprising:
a hub;
a set of legs including at least first and second legs, each leg of the set of legs including a head, each head being pivotably connected to the hub for pivoting about a respective pivot axis, each leg being pivotable with respect to the hub about the respective pivot axis outward from a stowed position to at least one operational pivoted position; and
leg angle stop structure including a first stop and a corresponding first set of blockers, at least one of the first leg or the hub including the first stop, the other of the at least one of the first leg or the hub including the first set of blockers, the first set of blockers comprising a first first leg blocker and a second first leg blocker, at least one of the first stop or the first set of blockers being movable with respect to the hub to selectively arrange the first stop in registration with at least one of the first first leg blocker or second first leg blocker, the first first leg blocker arranged to engage the first stop when the first stop is in registration with the first first leg blocker to stop outward pivoting of the first leg at a first preset operational pivoted positon of the first leg, the second first leg blocker arranged to engage the first stop when the first stop is in registration with the second first leg blocker to stop outward pivoting of the first leg at a second preset operational pivoted position of the first leg, the first leg being pivotable outward a greater degree from the stowed position to the second preset operational pivoted position than from the stowed position to the to the first preset operational pivoted position.

2. A multi-legged equipment support as set forth in claim 1, further comprising a first actuator, the first actuator being movable to preset locations to move the at least one of the first stop or the first set of blockers to selectively arrange the first stop with respect to the first set of blockers, a first preset location of the first actuator corresponding to the first stop being in registration with the first first leg blocker, and a second preset location of the actuator corresponding to the first stop being in registration with the second first leg blocker.

3. A multi-legged equipment support as set forth in claim 2, wherein the actuator is movable in a first direction from the first preset location to the second preset location and movable in a second direction opposite the first direction from the second preset location to the first preset location, the actuator being free of a bias biasing the actuator in the first direction and free of a bias biasing the actuator in the second direction.

4. A multi-legged equipment support as set forth in claim 2, further comprising a retainer arranged to maintain the first actuator in at least one of the first preset location or the second preset location irrespective of engagement of the first stop with the first set of blockers.

5. A multi-legged equipment support as set forth in claim 4, wherein the retainer is arranged to maintain the first actuator in the first preset location and the second preset location.

6. A multi-legged equipment support as set forth in claim 4, wherein the retainer comprises a detent.

7. A multi-legged equipment support as set forth in claim 6, wherein the detent is biased toward a retaining position.

8. A multi-legged equipment support as set forth in claim 7, wherein the first actuator is movable in a first direction to change registration of the stop with the first first leg blocker to registration of the stop with the second first leg blocker, and movable in a second direction opposite the first direction to change registration of the stop with the second first leg blocker to registration of the stop with the first first leg blocker.

9. A multi-legged equipment support as set forth in claim 8, wherein the detent is arranged to be displaced from the retaining position to permit movement of the first actuator in the first direction responsive to force on the actuator tending to move the actuator in the first direction.

10. A multi-legged equipment support as set forth in claim 9, wherein the first actuator includes a first end portion and a second end portion opposite the first end portion, the first and second end portions being located to be pushed by a finger of a user to move the first actuator between the first and second preset locations.

11. A multi-legged equipment support as set forth in claim 10, wherein the first actuator comprises a slide, the slide having an intermediate portion housed in the head of the first leg, the first and second end portions being exposed outside the head of the first leg.

12. A multi-legged equipment support as set forth in claim 11, wherein the actuator comprises a first indicator, the first indicator corresponding to the first preset location of the first actuator, the first indicator being arranged to be exposed for view by a user when the first actuator is in the first preset location and to be hidden from view by the user when the first actuator is not in the first preset location.

13. A multi-legged equipment support as set forth in claim 12, wherein the actuator comprises a second indicator, the second indicator corresponding to the second preset location of the first indicator, the second indicator being arranged to be exposed for view by the user when the first actuator is in the second preset location and to be hidden from view by the user when the first actuator is not in the second preset location.

14. A multi-legged equipment support as set forth in claim 13, further comprising an opening in at least one of the hub or the head of the first leg, the first indicator being exposed at the opening when the first actuator is in the first preset location, and the second indicator being exposed at the opening when the first actuator is in the second preset location.

15. A multi-legged equipment support as set forth in claim 2, wherein the actuator comprises a first indicator, the first indicator corresponding to the first preset location of the first actuator, the first indicator being arranged to be exposed for view by a user when the first actuator is in the first preset location and to be hidden from view by the user when the first actuator is not in the first preset location.

16. A multi-legged equipment support as set forth in claim 1, wherein the first set of blockers comprises a third first leg blocker, the first stop being movable with respect to the first set of blockers to selectively arrange the first stop in registration with the third first leg blocker, the third first leg blocker arranged to engage the first stop when the first stop is in registration with the third first leg blocker to stop outward pivoting of the first leg at a third preset operational pivoted position of the first leg, the first leg being pivotable outward a greater degree from the stowed position to the third preset operational position than from the stowed position to the second preset operational pivoted position.

17. A multi-legged equipment support as set forth in claim 1, wherein the first leg includes the first stop, and the hub includes the first set of blockers, the stop being movable with respect to the head of the leg to selectively arrange the first stop with respect to the set of blockers.

18. A multi-legged equipment support as set forth in claim 1, wherein leg angle stop structure includes a second stop and a corresponding second set of blockers, at least one of the second leg or the hub including the second stop, the other of the at least one of the second leg or the hub including the second set of blockers, the second set of blockers comprising a first second leg blocker and a second second leg blocker, at least one of the second stop or the second set of blockers being movable with respect to the hub to selectively arrange the second stop in registration with at least one of the first second leg blocker and second second leg blocker, the first second leg blocker arranged to engage the second stop when the second stop is in registration with the first second leg blocker to stop outward pivoting of the second leg at a first preset operational pivoted positon of the second leg, the second second leg blocker arranged to engage the second stop when the second stop is in registration with the second second leg blocker to stop outward pivoting of the second leg at a second preset operational pivoted position of the second leg, the second leg being pivotable outward a greater degree from the stowed position to the second preset operational pivoted position than from the stowed position to the to the first preset operational pivoted position.

19. A multi-legged equipment support comprising:
a hub;
a set of legs including at least first and second legs, each leg of the set of legs including a head, each head being pivotably connected to the hub for pivoting about a respective pivot axis, at least the first leg being pivotable with respect to the hub about the respective pivot axis outward from a stowed position to at least first and second preset operational pivoted positions;
a first actuator associated with the first leg, the first actuator being movable with respect to the head of the first leg between first and second preset locations, the first leg being pivotable outward from the stowed position to the first preset operational pivoted position when the first actuator is in the first preset location, the first leg being pivotable outward from the stowed position to a second preset operational pivoted position different from the first preset operational pivoted position when the first actuator is in the second preset location; and
a retainer arranged to maintain the first actuator in at least one of the first preset location or the second preset location irrespective of the first leg being in the first or second operational pivoted positions.

20. A multi-legged equipment support as set forth in claim 19, further comprising:
a second actuator associated with the second leg, the second actuator being movable between first and second preset locations with respect to the head of the second leg, the second leg being pivotable outward from the stowed position to the first preset operational pivoted position when the second actuator is in the first preset location, the second leg being pivotable outward from the stowed position to a second preset operational pivoted position different from the first preset operational pivoted position when the second actuator is in the second preset location; and
a second retainer arranged to maintain the second actuator in at least one of the first preset location or the second preset location irrespective of second leg being in the first or second operational pivoted positions.
